(19) United States
(12) Patent Application Publication
(10) Pub. No.: US 2020/0247962 A1
(43) Pub. Date: Aug. 6, 2020

(54) RESIN REINFORCING FIBERGLASS AND THERMOPLASTIC RESIN COMPOSITION

(71) Applicant: ASAHI KASEI KABUSHIKI KAISHA, Tokyo (JP)

(72) Inventor: Minoru SAKATA, Tokyo (JP)

(73) Assignee: ASAHI KASEI KABUSHIKI KAISHA, Tokyo (JP)

(21) Appl. No.: 16/780,903

(22) Filed: Feb. 4, 2020

(30) Foreign Application Priority Data
Feb. 5, 2019 (JP) 2019-019095

(51) Int. Cl. C08J 5/08; C08K 7/14; C08K 5/544; C08K 5/1539; C08K 5/5435; C08K 9/08; C08L 53/00

(52) U.S. Cl. CPC C08J 5/08; C08J 2351/08; C08K 5/544; C08K 5/1539; C08K 5/5435; C08K 9/08; C08L 53/00; C08K 2201/004; C08K 2201/003; C08J 2351/06; C08J 2371/12; C08J 2333/20; C08J 2325/10; C08J 2325/06; C08K 7/14

(57) ABSTRACT

The present disclosure aims to provide a resin reinforcing fiberglass, which has a high adhesiveness with a thermoplastic resin for enhancing the mechanical strength and the anti-mold fouling property of a thermoplastic resin composition, and a thermoplastic resin composition including such a fiberglass. A resin reinforcing fiberglass comprises (a) a fiberglass, and (b) a silane coupling agent and (c) a maleic anhydride grafted polymer, which are adhered to a surface of the (a) fiberglass.

### TECHNICAL FIELD

The present disclosure relates to a resin reinforcing fiberglass and a thermoplastic resin composition.

### BACKGROUND

A fiberglass has been used for reinforcing thermoplastic resins, and such a fiberglass is subjected to a surface treatment with various treatment agents for improving the adhesion with thermoplastic resins. Examples of typical treatment agents for the surface treatment include silane coupling agents, urethane resins, and epoxy resins, and their compositions are selected in view of a desired adhesion with a thermoplastic resin, desired thermal stability during processing, and the like (see PTL 1, PTL 2, and PTL 3, for example).

Further, a fiberglass subjected to a surface treatment with a copolymer of maleic anhydride and an unsaturated monomer and a silane coupling agent is disclosed (see PTL 4, for example).

### CITATION LIST

### Patent Literature

PTL 1: JP S58-098353 A

PTL 2: JP S60-046951 A

PTL 3: WO 2005/092814 A1

PTL 4: JP S60-044535 A

### SUMMARY

The adhesion between a thermoplastic resin and a fiberglass subjected to a surface treatment with a conventional treatment agent, however, remains insufficient, and the mechanical properties, such as the impact strength and the bending strength, of the reinforced thermoplastic resins have not yet been satisfactory. In addition, although urethane resins, epoxy resins, and a copolymer of maleic anhydride and an unsaturated monomer provide an excellent fiber sizing effect, they may cause mold fouling as mold deposits during molding of a resin composition including any of such treatment agents.

It is an aim of the present disclosure to provide a resin reinforcing fiberglass, which has a high adhesiveness with a thermoplastic resin for enhancing the mechanical strength and the anti-mold fouling property of a thermoplastic resin composition, and a thermoplastic resin composition including such a fiberglass.

Intensive studies for achieving the above-mentioned aim have resulted in findings that a surface treatment of a fiberglass with a treatment agent containing a silane coupling agent and a maleic anhydride grafted polymer can enhance the adhesion of the resin reinforcing fiberglass with a thermoplastic resin, and that reinforced thermoplastic resin compositions having excellent mechanical properties and reduced mold fouling can be obtained by using a resin reinforcing fiberglass subjected to a surface treatment with such a treatment agent, which has lead to the present disclosure.

Namely, the present disclosure is as follows:

(1) A resin reinforcing fiberglass comprising:

(a) a fiberglass; and

(b) a silane coupling agent and (c) a maleic anhydride grafted polymer, which are adhered to a surface of the (a) fiberglass.

(2) The resin reinforcing fiberglass according to (1), wherein the fiberglass is in a form selected from the group consisting of a roving, chopped strands, milled fibers, yarns, a woven fabric, and a nonwoven fabric.

(3) The resin reinforcing fiberglass according to (1) or (2), wherein 0.03 to 1.00% by mass of the (b) silane coupling agent, and the (c) maleic anhydride grafted polymer are adhered to the surface of 94.0 to 99.92% by mass of the (a) fiberglass.

(4) The resin reinforcing fiberglass according to any of (1) to (3), wherein the (b) silane coupling agent, and 0.05 to 5.00% by mass of the (c) maleic anhydride grafted polymer are adhered to the surface of 94.0 to 99.92% by mass of the (a) fiberglass.

(5) The resin reinforcing fiberglass according to any one of (1) to (4), wherein the (b) silane coupling agent has an amino group or an epoxy group.

(6) The resin reinforcing fiberglass according to any one of (1) to (5), wherein the (c) maleic anhydride grafted polymer is a polymer in which maleic anhydride is grafted to a polyphenylene ether, or in which maleic anhydride is grafted to a hydrogenated block copolymer resultant from a hydrogenation of a block copolymer containing two or more polymer blocks A composed mainly of a vinyl aromatic compound and one or more polymer blocks B composed mainly of a conjugated diene compound.

(7) The resin reinforcing fiberglass according to any one of (1) to (6), wherein the (c) maleic anhydride grafted polymer has a maleic anhydride grafting content of 0.1 to 1.0% by mass.

(8) A thermoplastic resin composition comprising:

a thermoplastic resin; and

the resin reinforcing fiberglass according to any one of (1) to (7).

(9) The thermoplastic resin composition according to (8), wherein the thermoplastic resin comprises a polystyrene resin.

(10) The thermoplastic resin composition according to (8) or (9), wherein the thermoplastic resin comprises a polyphenylene ether resin.

The resin reinforcing fiberglass of the present disclosure can provide a reinforced thermoplastic resin composition having a high adhesiveness with a thermoplastic resin and excellent mechanical strength and anti-mold fouling property.

### BRIEF DESCRIPTION OF THE DRAWINGS

In the accompanying drawings:

FIG. 1 is a scanning electron microscope image of a cross-section of a molded article formed from a thermoplastic resin composition of Example 12;

FIG. 2 is a scanning electron microscope image of a cross-section of a molded article formed from a thermoplastic resin composition of Example 19; and

FIG. 3 is a scanning electron microscope image of a cross-section of a molded article formed from a thermoplastic resin composition of Comparative Example 5.

### DETAILED DESCRIPTION

Hereinafter, an embodiment for embodying the present disclosure (hereinafter referred to merely as “the present embodiment”) will be described in detail. The present disclosure is not limited to the following embodiment, but may be practiced in various modifications without departing from the scope of the subject thereof.

«Resin Reinforcing Fiberglass»

A resin reinforcing fiberglass of the present embodiment includes (a) a fiberglass, and (b) a silane coupling agent and (c) a maleic anhydride grafted polymer, which are adhered to a surface of the (a) fiberglass.

Preferably, the resin reinforcing fiberglass of the present embodiment is provided in the form of a roving; chopped strands; milled fibers; yarns; a woven fabric such as a glass cloth in plain weave, satin weave, twill weave, etc., woven from yarns, a roving cloth woven from rovings, and a knitted fabric; or a nonwoven fabric, including a short fiber mat such as chopped strands mat and a surfacing mat, or a long fiber mat such as a diamond mat and a swirl mat. Of these, from the viewpoint of handling upon fabrication of a resin composition by melt-mixing with a resin, a form of a roving, chopped strands, or milled fibers is more preferable. In addition, from the viewpoint of ease of handling upon being mixed with a resin dissolved in a solvent, a form of a glass cloth or a nonwoven fabric can also be suitably used.

(a) Fiberglass

The (a) fiberglass used in the present embodiment will be described.

The form of the (a) fiberglass is not particularly limited, and examples thereof include a roving; chopped strands; milled fibers; yarns; a woven fabric such as a glass cloth in plain weave, satin weave, twill weave, etc., woven from yarns, a roving cloth woven from rovings, and a knitted fabric; or a nonwoven fabric, including a short fiber mat such as chopped strands mat and a surfacing mat, or a long fiber mat such as a diamond mat and a swirl mat, for example. Of these, from the viewpoint of handling upon fabrication of a resin composition by melt-mixing with a resin, a form of a roving, chopped strands, or milled fibers is more preferable. In a case in which the resin is dissolved in a solvent to be mixed with the fiberglass, a cloth, a mat, a nonwoven fabric, and the like can be suitably used.

The average fiber length of the (a) fiberglass is preferably 1 mm or longer, more preferably 1.5 mm or longer, and even more preferably 3 mm or longer.

The average fiber diameter of the (a) fiberglass is preferably 3 to 30 μm, more preferably 5 to 20 μm, and even more preferably 6 to 15 μm.

The content of the (a) fiberglass in the resin reinforcing fiberglass is preferably 94.0 to 99.92% by mass, more preferably 95.0 to 99.90% by mass, and even more preferably 95.0 to 99.0% by mass, relative to 100% by mass of the resin reinforcing fiberglass, from the viewpoint of the mechanical strength and anti-mold fouling property.

(b) Silane Coupling Agent

As the (b) silane coupling agent used in the present embodiment, organosilane coupling agents commonly used as a treatment agent for a fiberglass can be used, and of these, an aminosilane or epoxysilane coupling agent is suitably used.

These silane coupling agents may be used alone or in a combination of two or more thereof.

The (b) silane coupling agent described above preferably has at least an amino group or an epoxy group as a functional group to react with an organic group. Non-limiting examples of the aminosilane coupling agent include N-(2-aminoethyl) 3-aminopropylmethyl dimethoxysilane, N-(2-aminoethyl) 3-aminopropyl trimethoxysilane, and 3-aminopropyl triethoxysilane. Non-limiting examples of the epoxy silane coupling agent include γ-glycidoxypropyl trimethoxysilane, 2-(3,4-epoxycyclohexyl) ethyl trimethoxysilane, 3-glycidoxypropylmethyl dimethoxysilane, and 3-glycidoxypropyl triethoxysilane.

(c) Maleic Anhydride Grafted Polymer

The (c) maleic anhydride grafted polymer used in the present embodiment is a graft polymer having maleic anhydride grafted (added) to the polymer structure. This graft polymer is not a polymer (copolymer) of components that are added upon polymerization, but is one in which maleic anhydride is added after polymerization in the presence or absence of a peroxide followed by a heat treatment, to thereby graft maleic anhydride. Specifically, it can be produced in the procedure described in the EXAMPLES section below.

Examples of the peroxide include dicumyl peroxide, di-tent-butyl peroxide, tent-butyl cumyl peroxide, 2,5-dimethyl-2,5-di(tert-butylperoxy) hexane, 2,5-dimethyl-2,5-di(tert-butylperoxy)-3 hexyne, n-butyl-4,4-bis(tert-butylperoxy) valerate, and 1,1-bis(tert-butylperoxy) 3,3,5-trimethyl cyclohexane.

Examples of the base polymer of the above-described (c) maleic anhydride grafted polymer include, but are not particularly limited to, a polystyrene, a polyacrylonitrile styrene, a polyphenylene ether, a styrene-butadiene copolymer and a hydrogenated product thereof, and a hydrogenated block copolymer resultant from a hydrogenation of a block copolymer containing two or more polymer blocks A composed mainly of a vinyl aromatic compound and one or more polymer blocks B composed mainly of a conjugated diene compound. The base polymer can be selected in view of the decomposability of the copolymer as such, the reactivity and miscibility with the (b) silane coupling agent and the thermoplastic resin to be mixed with, and base polymers may be used alone or in a combination of two or more thereof.

Of these, preferable are a polyphenylene ether resin and a hydrogenated block copolymer resultant from a hydrogenation of a block copolymer containing two or more polymer blocks A mainly composed of a vinyl aromatic compound and one or more polymer blocks B mainly composed of a conjugated diene compound, in view of their excellent affinities with a number of thermoplastic resins.

Hereinafter, a description will be provided for a hydrogenated block copolymer resultant from a hydrogenation of a block copolymer containing two or more polymer blocks A composed mainly of a vinyl aromatic compound and one or more polymer blocks B composed mainly of a conjugated diene compound.

The term “polymer block A composed mainly of a vinyl aromatic compound” refers to a homopolymer block of a vinyl aromatic compound, or a copolymer block of a vinyl aromatic compound and a conjugated diene compound in which the content of the vinyl aromatic compound in the polymer block A is more than 50% by mass, preferably 70% by mass or more. The polymer blocks A may be substantially free or free of any conjugated diene compounds. It should be noted that the expression “substantially free of” includes a case where a substance of interest is included in the content within a range not impairing the effect of the present disclosure, and the content may be, for example, 3% by mass or less relative to the total amount of the block.

In contrast, the term “polymer block B composed mainly of a conjugated diene compound” refers to a homopolymer block of a conjugated diene compound, or a copolymer block of a conjugated diene compound and a vinyl aromatic compound in which the content of the conjugated diene compound in the polymer block B is more than 50% by mass, preferably 70% by mass or more. The polymer blocks B may be substantially free or free of any vinyl aromatic compounds. It should be noted that the expression “substantially free of” includes a case where a substance of interest is included in the content within a range not impairing the effect of the present disclosure, and the content may be, for example, 3% by mass or less relative to the total amount of the block.

The hydrogenated block copolymer may be a combination of two hydrogenated block copolymers, a combination of hydrogenated block copolymers that have been conventionally known and commercially available. Any of hydrogenated block copolymers satisfying the above-described definition of hydrogenated block copolymers may be used.

As the vinyl aromatic compound constituting the hydrogenated block copolymer, for example, one or two or more of styrene, a-methylstyrene, vinyltoluene, p-tert-butylstyrene, diphenylethylene, and the like can be selected, and styrene is particularly preferable.

As the conjugated diene compound constituting the hydrogenated block copolymer, for example, one or two or more of butadiene, isoprene, 1,3-pentadiene, 2,3-dimethyl-1,3-butadiene, and the like can be selected, and butadiene, isoprene, and their combination are particularly preferable.

The bonding form of the butadiene prior to hydrogenation is typically determined by an infrared spectrophotometer, a nuclear magnetic resonance (NMR) spectrometer, or the like.

The hydrogenated block copolymer is a hydrogenated block copolymer containing two or more blocks A and one or more blocks B, and is preferably a hydrogenated product of a vinyl aromatic compound-conjugated diene compound block copolymer in which block units are bonded to form the A-B-A structure (where the molecular weights of the two As and the one B may be the same or different).

The polymer blocks A composed mainly of a vinyl aromatic compound and the polymer blocks B composed mainly of a conjugated diene compound may have structures where the distribution of the vinyl aromatic compound in the molecular chain in the block A and the conjugated diene compound in the molecular chain in the block B is random or tapered (the density of the monomer component increases or decreases along the molecular chain), or in any of other configurations. In the case where the hydrogenated block copolymer includes two or more blocks A and/or two or more blocks B, the polymer blocks A may be of the same structure or different structures and/or the polymer blocks B may be of the same structure or different structures.

The at least one polymer block B included in the hydrogenated block copolymer may be a polymer block having a 1,2-vinyl bonding amount of the conjugated diene compound prior to hydrogenation of 70 to 90%. The at least one polymer block B included in the hydrogenated block copolymer may be a polymer block including a polymer block having a 1,2-vinyl bonding amount of the conjugated diene compound before hydrogenation of 70 to 90% (hereinafter, such a polymer block is referred to as “polymer block B1”), and another polymer block having a 1,2-vinyl bonding amount of the conjugated diene compound before hydrogenation of 30% or more and less than 70% (hereinafter, such a polymer block is referred to as “polymer block B2”). A block copolymer having such a block structure is represented by A-B2-B1-A, for example, and can be prepared, by any known polymerization technique in which the 1,2-vinyl bonding amount is controlled based on the adjusted feed sequences of the respective monomer units.

The content of the vinyl aromatic compound bound in the hydrogenated block copolymer is preferably 15 to 80% by mass, more preferably 25 to 80% by mass, and even more preferably 30 to 75% by mass.

The hydrogenated block copolymer can be used as a hydrogenated copolymer block (hydrogenated product of vinyl aromatic compound-conjugated diene compound block copolymer) by carrying out a hydrogenation reaction upon hydrogenating aliphatic double bonds in the polymer blocks B mainly composed of a conjugated diene compound, or the like. The hydrogenation ratio of such aliphatic double bonds is preferably 80% or more, more preferably 95% or more.

The hydrogenation ratio is typically determined by an infrared spectrophotometer, a nuclear magnetic resonance (NMR) spectrometer, or the like.

The number-average molecular weight (Mnc) of the hydrogenated block copolymer is preferably 120,000 to 300,000, more preferably 120,000 to 250,000, and even more preferably 150,000 to 250,000. The number-average molecular weight is preferably 120,000 or more from the viewpoint of the impact resistance, and is preferably 300,000 or less from the viewpoint of the dispersibility to the (a) component and the fluidity.

The number-average molecular weight (Mnc) of the hydrogenated block copolymer can be determined in the following procedure. Using a gel permeation chromatography System21 manufactured by Showa Denko K.K. (columns: one K-G, one K-800RL, and one K-800R, manufactured by Showa Denko K.K., connected in series; column temperature: 40° C.; solvent: chloroform; solvent flow rate: 1.0 mL/min; and sample concentration: 1 g/L chloroform solution of a hydrogenation block copolymer), a calibration curve is plotted using standard polystyrenes (standard polystyrenes having molecular weights of 3,650,000, 2,170,000, 1,090,000, 681,000, 204,000, 52,000, 30,200, 13,800, 3,360, 1,300, and 550). Measurements on both the standard polystyrenes and hydrogenation block copolymer can be carried out by setting the ultraviolet (UV) wavelength of a detector to 254 nm.

The number-average molecular weight (MncA) of at least one of the polymer blocks A contained in the hydrogenated block copolymer is preferably 10,000 or more, more preferably 15,000 or more, and even more preferably more than 15,000, for achieving a further excellent impact resistance. Furthermore, the number-average molecular weight (MncA) of all of the polymer blocks A contained in the hydrogenated block copolymer is preferably 10,000 or more for achieving a further excellent impact resistance.

For hydrogenated block copolymer having the A-B-A structure, for example, the number-average molecular weight (MncA) of the polymer blocks A composed mainly of a vinyl aromatic compound in the hydrogenated block copolymer can be calculated based on the above-described number-average molecular weight (Mnc) of the hydrogenated block copolymer by the following equation: MncA=Mnc×(ratio of vinyl aromatic compounds that are bound)/2, assuming that the molecular weight distribution of the hydrogenated block copolymer is 1 and that the two polymer blocks A composed mainly of a vinyl aromatic compound have the same molecular weight. Similarly, for the block copolymer components in the A-B-A-B structure, MncA can be determined by the following equation: MncA=Mnc×(ratio of vinyl aromatic compounds that are bound)/3. If the sequence of the block structures A and the block structures B are known beforehand prior to synthesis of the vinyl aromatic compound-conjugated diene compound block copolymer, MncA can be determined from the proportion of block structures A, without relying on the above equations, using the determined number-average molecular weight (Mnc).

The hydrogenated block copolymer preferably contains a polymer block B having a number-average molecular weight (MncB) of 15,000 or more, and more preferably contains a polymer block B having a number-average molecular weight of 40,000 or more for achieving a further excellent impact resi stance.

The number-average molecular weight (MncB) of the polymer blocks B composed mainly of a conjugated diene compound contained in the hydrogenated block copolymer can be determined in the same manner as described above.

Particularly, it is preferable that the hydrogenated block copolymer has a number-average molecular weight (Mnc) of 120,000 to 300,000 and contains polymer blocks A having a number-average molecular weight (MncA) of 10,000 or more.

The hydrogenated block copolymer may be any of hydrogenated block copolymers obtained by any of conventionally known production methods, as long as it has the above-described structure.

The maleic anhydride grafting content of the (c) maleic anhydride grafted polymer is preferably 0.1 to 1.0% by mass, more preferably 0.2 to 1.0% by mass, and even more preferably 0.3 to 0.8% by mass, relative to 100% by mass of the (c) maleic anhydride grafted polymer.

A maleic anhydride grafting content of the (c) maleic anhydride grafted polymer of 0.1% by mass or more can reduce any unevenness of the adhesion to the (b) silane coupling agent, which improves the adhesion between the thermoplastic resin to be reinforced and the resin reinforcing fiberglass, achieving providing a thermoplastic resin composition having higher mechanical properties. At the same time, a maleic anhydride grafting content of 1.0% by mass or less ensures sufficient advantages in return for the increase in the grating amount. Further, operations, such as increasing the concentration of the treatment agent or treating twice, can be eliminated upon carrying out the treatment, thereby enhancing the productivity.

The maleic anhydride grafting content can be determined by measuring the absorption-peak ratio of the respective components by an infrared spectrophotometer (IR) or by a neutralization titration method or the like.

In addition to the (b) silane coupling agent and the (c) maleic anhydride grafted polymer, one or more other additive, such as a fiber sizing agent, a lubricant, and an antistatic agent, can be blended as components of the treatment agent for the (a) fiberglass without departing from the object and without hindering the effects of the present embodiment.

The content of the other additive(s) in the resin reinforcing fiberglass may be 10% by mass or less relative to 100% by mass of the resin reinforcing fiberglass.

Next, the treatment process for the resin reinforcing fiberglass and the amount of the treatment agent adhered to the (a) fiberglass in the present embodiment will be described.

First, examples of the treatment process include, but are not particularly limited to, impregnating a fiberglass with a treatment solution containing the treatment agent emulsified or dissolved in an organic solvent by a conventional technique, and coating a fiberglass with the treatment agent in a molten state.

In the above treatment process, the treatment agent employed may be either one-component type or two-component type. More specifically, the process employed may be any of a process in which one surface treatment is carried out using a treatment agent containing both a (b) silane coupling agent and a (c) maleic anhydride grafted polymer in a single step; a process in which a surface treatment with a treatment agent containing a (c) maleic anhydride grafted polymer is carried out first, followed by a surface treatment with a treatment agent containing a (b) silane coupling agent; and a process in which a surface treatment with a treatment agent containing a (b) silane coupling agent is carried out first, followed by a surface treatment with a treatment agent containing a (c) maleic anhydride grafted polymer. Furthermore, the treatment agent may be of the three-component type or of a type having four or more components.

The adhesion amounts of the treatment agents in the resin reinforcing fiberglass are preferably 0.03 to 1.00% by mass for the (b) silane coupling agent, and 0.05 to 5.00% by mass for the (c) maleic anhydride grafted polymer, relative to the total weight of the resin reinforcing fiberglass. Preferably, the adhesion amounts of the (b) silane coupling agent and the (c) maleic anhydride grafted polymer are 0.10 to 0.80% by mass and 0.30 to 3.00% by mass, respectively. More preferably, the adhesion amounts of the (b) silane coupling agent and the (c) maleic anhydride grafted polymer are 0.20 to 0.80% by mass and 0.30 to 2.50% by mass, respectively.

An adhesion amount of the (b) silane coupling agent of 0.03% by mass or more can reduce any unevenness of the adhesion of the (b) silane coupling agent, which improves the adhesion between the thermoplastic resin to be reinforced and the resin reinforcing fiberglass, thereby providing a thermoplastic resin composition having excellent mechanical properties. At the same time, an adhesion amount of 1% by mass or less ensures sufficient advantages in return for the increase in the adhesion amount. Further, operations, such as increasing the concentration of the (b) silane coupling agent or treating twice, can be eliminated upon carrying out the treatment, thereby enhancing the productivity.

On the other hand, an adhesion amount of the (c) maleic anhydride grafted polymer of 0.05% by mass or more can further improve the adhesion between the thermoplastic resin and the resin reinforcing fiberglass, thereby providing a thermoplastic resin composition having excellent mechanical properties. At the same time, an adhesion amount of 5% by mass or less ensures sufficient advantages in return for the increase in the adhesion amount.

«Thermoplastic Resin Composition»

The thermoplastic resin composition of the present embodiment includes the resin reinforcing fiberglass of the present embodiment and a thermoplastic resin.

Examples of the thermoplastic resin include a polyphenylene ether resin, a polyolefin resin, an acrylonitrile-styrene copolymer resin, an acrylonitrile-butadiene-styrene copolymer resin, a polystyrene resin, and a polyamide resin.

The thermoplastic resin composition of the present embodiment preferably contains 3 to 70% by mass of the resin reinforcing fiberglass and 30 to 97% by mass of the thermoplastic resin, relative to 100% by mass of the thermoplastic resin composition. More preferably, the content of the resin reinforcing fiberglass is 5 to 70% by mass, and the content of the thermoplastic resin is 30 to 95% by mass. Even more preferably, the content of the resin reinforcing fiberglass is 5 to 60% by mass, and the content of the thermoplastic resin is 40 to 95% by mass. The above compositions enable the thermoplastic resin composition of the present embodiment to exhibit even further well-balanced physical properties in terms of the impact resistance and the heat resistance.

Hereinafter, specific examples of thermoplastic resin of the present embodiment will be described.

(1. Polyphenylene Ether Resin)

The thermoplastic resin of the present embodiment employed can be a polyphenylene ether (PPE) resin.

Examples of the polyphenylene ether resin include, but are not particularly limited to, a resin composed only of a polyphenylene ether, and a resin mixture composed of a polyphenylene ether and a polystyrene resin (modified polyphenylene ether resin).

Examples of the polyphenylene ether include, but are not particularly limited to, homopolymers formed of a repeating unit represented by the following formula (1), and copolymers having a repeating unit represented by the following formula (1).

These PPEs may be used alone or in a combination of two or more thereof.

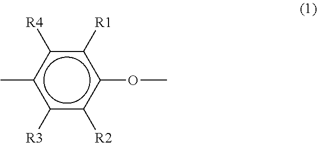

In the above formula (1), R1, R2, R3 and R4 are each independently a monovalent group selected from the group consisting of a hydrogen atom, a halogen atom, a primary alkyl group having a carbon atom number of 1 to 7, a secondary alkyl group having a carbon atom number of 1 to 7, a phenyl group, a haloalkyl group, an aminoalkyl group, an oxyhydrocarbon group, and an oxyhalohydrocarbon group in which a halogen atom and an oxygen atom are separated by at least two carbon atoms.

Examples of the polystyrene resin contained in the polyphenylene ether resin include an atactic polystyrene, a rubber-reinforced polystyrene (high impact polystyrene, HIPS), a styrene-acrylonitrile copolymer (AS) having a styrene content of 50% by weight or more, and an AS resin in which such a styrene-acrylonitrile copolymer is reinforced with a rubber. Of these, an atactic polystyrene and/or a high impact polystyrene are preferable.

These polystyrene resins may be used alone or in a combination of two or more thereof.

(2. Polystyrene Resin)

The thermoplastic resin of the present embodiment employed can be a polystyrene (PS) resin.

Examples of the polystyrene resin include polymers obtained by polymerizing a monomer component containing a styrenic compound. The monomer component may include a compound copolymerizable with the styrenic compound.

These polystyrene resins may be used alone or in a combination of two or more thereof.

The polystyrene resin preferably contains more than 60% by mass, more preferably 70% by mass or more, of constituent units derived from a styrenic compound, relative to 100% by mass of the styrene resin.

Examples of the styrenic compound include, but are not limited to, styrene, α-methyl styrene, 2,4-dimethyl styrene, monochlorostyrene, p-methylstyrene, p-tert-butylstyrene, and ethylstyrene. In particular, styrene is preferably used from the viewpoint of the practicality of the raw material.

Examples of the compound copolymerizable with the styrenic compound include methacrylic acid esters such as methyl methacrylate and ethyl methacrylate, and acid anhydrides such as maleic anhydride.

The amount of the compound copolymerizable with the styrenic compound is preferably 95% by mass or less, more preferably 90% by mass or less, relative to the total amount of the styrenic compound and the compound copolymerizable with the styrenic compound.

Examples of the polystyrene resin include an atactic polystyrene and a rubber-reinforced polystyrene (high impact polystyrene, HIPS). Of these, an atactic polystyrene and/or a high impact polystyrene are preferable.

(3. Acrylonitrile-Styrene Copolymer Resin)

The thermoplastic resin of the present embodiment employed can be an acrylonitrile-styrene copolymer resin.

Examples of the acrylonitrile-styrene copolymer resin include an acrylonitrile-styrene copolymer resin (AS resin) and a rubber-reinforced acrylonitrile-styrene copolymer resin (ABS resin). Of these, an ABS resin and/or an AS resin are preferable.

The acrylonitrile-styrene copolymer resin preferably contains more than 50% by mass, more preferably 55% by mass or more, of constituent units derived from a styrenic compound, relative to 100% by mass of the acrylonitrile-styrene copolymer resin.

The acrylonitrile-styrene copolymer resin is obtained, for example, by polymerization of a vinyl cyanide monomer and an aromatic vinyl monomer.

Examples of the vinyl cyanide monomer include acrylonitrile, methacrylonitrile, α-chloracrylonitrile, and α-ethylacrylonitrile. Of these, acrylonitrile is preferably used, but a mixture of two or more of these may be used.

Examples of the aromatic vinyl monomer include styrene; alkyl substituent styrenes having a substituent such as α-methyl styrene, p-methylstyrene, 3,5 -dimethyl styrene, 4 -methoxy styrene, and 2-hydroxystyrene; halogenated styrenes such as α-bromstyrene and 2,4-dichlorostyrene; 1-vinylnaphthalene; and divinyl benzene. Of these, styrene is preferably used, but a mixture of two or more of these may be used.

(4. Polyamide Resin)

The thermoplastic resin of the present embodiment employed can be a polyamide (PA) resin.

Any of polyamide resins having an amide bond, namely —NH—C(═O)—, in the repeating unit of the polymer main chain may be used.

The polyamide resin is, for example, a polymer or copolymer containing an amino acid, or a lactam, or a diamine and a dicarboxylic acid, as a main raw material(s).

Typical examples of the raw materials for the polyamide resin include amino acids such as 6-aminocaproic acid, 11-aminoundecanoic acid, 12-aminododecanoic acid, and para-aminomethylbenzoic acid; lactams such as ε-caprolactam and ω-laurolactam; aliphatic diamines such as tetramethylene diamine, pentamethylene diamine, hexamethylene diamine, 2-methyl pentamethylene diamine, nonamethylene diamine, decamethylene diamine, undecamethylene diamine, dodecamethylene diamine, 2,2,4-/2,4,4-trimethyl hexamethylene diamine, and 5-methylnonamethylene diamine; aromatic diamines such as meta-xylylene diamine and para-xylylene diamine; alicyclic diamines such as 1,3-bis(aminomethyl) cyclohexane, 1,4-bis(aminomethyl) cyclohexane, 1-amino-3-aminomethyl-3,5,5-trimethyl cyclohexane, bis(4-aminocyclohexyl) methane, bis(3-methyl-4-aminocyclohexyl) methane, 2,2-bis(4-aminocyclohexyl) propane, bis(aminopropyl) piperazine, and aminoethylpiperazine; aliphatic dicarboxylic acids such as adipic acid, suberic acid, azelaic acid, sebacic acid, and dodecanedioic acid; aromatic dicarboxylic acids such as terephthalic acid, isophthalic acid, 2-chloroterephthalic acid, 2-methylterephthalic acid, 5-methylisophthalic acid, 5-sodium sulfoisophthalic acid, 2,6-naphthalenedicarboxylic acid, hexahydroterephthalic acid, and hexahydroisophthalic acid; and alicyclic dicarboxylic acids such as 1,4-cyclohexane dicarboxylic acid, 1,3-cyclohexane dicarboxylic acid, 1,2-cyclohexane dicarboxylic acid, and 1,3-cyclopentane dicarboxylic acid.

In the present embodiment, two or more polyamide homopolymers or copolymers derived from these raw materials may be blended.

Specific examples of the polyamide resin include Polyamide 6, Polyamide 66, Polyamide 46, Polyamide 410, Polyamide 56, Polyamide 510, Polyamide 610, Polyamide 612, Polyamide 106, Polyamide 1010, Polyamide 1012, Polyamide 11, Polyamide 12, Polyamide 4T, Polyamide 5T, Polyamide 61, Polyamide 6T, Polyamide 9T, Polyamide 101, Polyamide 10T, MXD6, MXD10, PXD6, PXD10, polyamide copolymers containing at least two of these different polyamide components, and mixtures thereof.

(5. Polyolefin Resin)

The thermoplastic resin of the present embodiment employed can be a polyolefin resin.

Examples of the polyolefin resin include an ethylene resin and a propylene (PP) resin, and a propylene resin is particularly preferable.

Examples of the polypropylene resin include a propylene homopolymer, a copolymer of propylene and other monomers, and modified products thereof.

The polypropylene resin is preferably crystalline, more preferably a crystalline propylene homopolymer or a crystalline propylene-ethylene block copolymer. The polypropylene resin may also be a mixture of a crystalline propylene homopolymer and a crystalline propylene-ethylene block copolymer.

The polypropylene resins may be used alone or in a combination of two or more thereof.

Examples of other monomers copolymerizable with propylene include α-olefins such as butene-1 and hexene-1. The polymerization form thereof is not particularly limited, and may be a random copolymer, a block copolymer, or the like.

(Other Components)

In addition to the above-mentioned components, the thermoplastic resin composition of the present embodiment may contain other components as required to the extent that the thermal conductivity, electric resistivity, fluidity, low volatile components, heat resistance, and flame retardance of the thermoplastic resin composition are not impaired.

Examples of the other components include, but are not limited to, a thermoplastic elastomer (such as a polyolefin elastomer), a heat stabilizer, an antioxidant, a metal deactivator, a crystal nucleating agent, a flame retardant (such as an organophosphate ester compound, an ammonium polyphosphate compound, a silicone flame retardant, and a phosphazene flame retardant), a plasticizer (such as a low molecular weight polyethylene, epoxidized soybean oil, polyethylene glycol, and a fatty acid ester), a weather (light) resistance improving agent, a slipping agent, an inorganic or organic filler and a reinforcing material (such as carbon fibers, polyacrylonitrile fibers, and aramid fibers), various colorants, and a mold releasing agents.

The content of the above-mentioned other components in the thermoplastic resin composition may be 30% by mass or less relative to 100% by mass of the thermoplastic resin composition.

«Impact Resistance of Thermoplastic Resin Composition»

The thermoplastic resin composition of the present embodiment preferably has a Charpy impact strength of 3 kJ/m² or greater, more preferably 5 kJ/m² or greater.

Charpy impact strengths can be measured in accordance with the JIS K7111-1, and specifically can be measured by the methods described in the EXAMPLES section.

«Method of Producing Thermoplastic Resin Composition»

The thermoplastic resin composition of the present embodiment can be produced by melt-kneading the resin reinforcing fiberglass and the thermoplastic resin described above, and as well as other components as required.

Examples of a melt kneader for melt-kneading include, but are not limited to, a single-screw extruder; a multi-screw extruder including a double-screw extruder; and a heat melt kneader by means of rolls, a kneader, a

Brabender plastograph, and a Banbury mixer, and a double-screw extruder is particularly preferable from the viewpoint of kneadability. Specific examples include the ZSK series manufactured by Coperion GmbH, the TEM series manufactured by Toshiba Machine Co., Ltd., and the TEX series manufactured by the Japan Steel Works, Ltd.

A preferred production method using an extruder will be described below.

The L/D (effective barrel length/barrel inner diameter) of the extruder is preferably 20 or more and 60 or less, more preferably 30 or more and 50 or less.

The configuration of the extruder is not particularly limited, but a preferred extruder includes a first raw material feed inlet provided upstream to the flow direction of raw materials, a first vacuum vent provided downstream to the first raw material feed inlet, a second raw material feed inlet provided downstream to the first vacuum vent (and optional third and fourth raw material feed inlets provided downstream to the second raw material feed inlet, if required), and a second vacuum vent provided downstream to the second raw material feed inlet, for example. Particularly, a more preferred extruder further includes a kneading section provided upstream to the first vacuum vent, another kneading section provided between the first vacuum vent and the second raw material feed inlet, and a further kneading section provided between the second to fourth raw material feed inlets and the second vacuum vent.

The method of feeding the raw materials to the second to fourth raw material feed inlets is not particularly limited, but it is preferable to feed the raw materials from a side opening of the extruder using a forced side feeder because the raw materials tend to be more stably fed than simply adding and feeding them from the openings of the second to fourth raw material feed inlets of the extruder.

In particular, in cases in which powders are included in the raw materials and reductions in generation of cross-linked products or carbides due to thermal hysteresis of the resin are desired, usage of a forced side feeder for feeding the raw materials from the extruder side is more preferred, and even more preferred is provision of respective forced side feeders to the second to fourth raw material feed inlets to thereby feed a powdery raw material in a divided manner.

For adding a liquid raw material, the raw materials is preferably fed to the extruder using a plunger pump, a gear pump, or the like.

The respective upper openings of the second to fourth raw material feed inlets of the extruder can also be used as openings for venting the air conveyed along with the raw materials.

The melt-kneading temperature and the screw rotation speed in the melt-kneading step of the thermoplastic resin composition are not particularly limited, but for favorable processing, a temperature equal to or higher than the melting point of a crystalline resin may be selected for the crystalline resin, and a temperature equal to or higher than the glass-transition temperature of an amorphous resin may be selected for the amorphous resin. Typically, any temperature from 200 to 370° C. may be selected, and the screw rotation speed may be set to 100 to 1200 rpm.

In one of specific production methods of the thermoplastic resin composition of the present embodiment using a twin-screw extruder, for example, a thermoplastic resin is fed to the first raw material feed inlet of the twin-screw extruder, the heat melt zone is set to the melting temperature of the resin, melt-kneading is carried out at a rotational speed of the screws of 100 to 1200 rpm, preferably 200 to 500 rpm, and further melt-kneading is carried out by adding a resin reinforcing fiberglass to the molten resin from the second raw material feed inlet. In addition, the thermoplastic resin may be fed to the twin-screw extruder via the second and third raw material feed inlets for feeding the components in a divided manner as described above, or all of the components may be fed at once from the first raw material feed inlet of the extruder.

Further, in order to reduce generation of cross-linked products and carbides due to thermal hysteresis of the resin in the presence of oxygen, it is preferable to maintain the oxygen concentrations of the respective process lines for the raw materials in the addition route to the extruder below 1.0% by volume. The above-mentioned addition route is not particularly limited, but a specific example includes piping, a gravitational feeder having a refill tank, piping, a feed hopper, and a twin-screw extruder, in this order, from stock tanks. For maintaining a low oxygen concentration as described above, although not particularly limited, introducing an inert gas to respective process lines having increased air-tightness is effective. Typically, nitrogen is preferably introduced to maintain the oxygen concentration to be less than 1.0% by volume.

In a case in which the thermoplastic resin contains a powdery component (having a volume mean particle size of less than 10 μm), the above-mentioned method of producing the thermoplastic resin composition provides an effect of further reducing resides in screws of a twin-screw extruder upon production of the thermoplastic resin composition of the present embodiment using the twin-screw extruder, and a further effect of reducing generation of black spot foreign matters, carbides, and the like in the thermoplastic resin composition obtained by the above-mentioned production method.

As a specific method of producing the thermoplastic resin composition of the present embodiment, it is preferable to use an extruder in which the respective oxygen concentrations at the raw material feed inlets are controlled to be less than 1.0% by volume, and to carry out one of the following methods 1 to 3:

1. A production method including melt-kneading a thermoplastic resin to be contained in the thermoplastic resin composition of the present embodiment (first kneading step); and feeding a resin reinforcing fiberglass to the molten-kneaded product generated in the first kneading step, followed by melt-kneading (second kneading step).

2. A production method including melt-kneading a part of a thermoplastic resin to be contained in the thermoplastic resin composition of the present embodiment (first kneading step); feeding the remainder of the thermoplastic resin to the molten-kneaded product generated in the first kneading step, followed by melt-kneading (second kneading step); and feeding a resin reinforcing fiberglass, followed by melt-kneading (third kneading step).

3. A production method including melt-kneading the entire amounts of a thermoplastic resin and a resin reinforcing fiberglass, which are to be contained in the thermoplastic resin composition of the present embodiment.

Of these, a thermoplastic resin composition obtained by the production method 1 or 2 is more preferable than a thermoplastic resin composition obtained by the production method 3 because the methods 1 and 2 are superior in the mixing of the components, can reduce decomposition due to thermal aging, generation of cross-linked products and carbides, can reduce breakage of a fiberglass, can increase the production volume per hour of the resin, and can provide a thermoplastic resin composition having excellent productivity and quality.

«Molded Article»

Molded articles containing the thermoplastic resin composition of the present embodiment can be widely used as molded articles, such as component parts of optical appliances, components around light source lamps, sheets or films for stack substrates of metallic films, internal components of hard disks, connector ferrules for optical fibers, printer components, copier components, plumbing pumps and piping members, components in automobile engine rooms such as parts of automobile radiator tanks, and components of lamps of automobiles. Molded articles containing the thermoplastic resin composition of the present embodiment are particularly suitable for protective enclosures for hybrid vehicles or battery systems for electric vehicles, for which flame retardance regulations have recently become stricter.

### EXAMPLES

While the present disclosure will be described with reference to specific examples and comparative examples, the present embodiment is not limited to these examples.

Raw materials used in Examples and Comparative Examples will be described.

[Resin Reinforcing Fiberglass]

### <(a) Component: Fiberglass>

E-glass fiber rovings that had an average fiber diameter of 10 μm and had not subjected to any surface treatment.

<(b) Component: Silane Coupling Agent>
(b1) 3-aminopropyl triethoxysilane (silane coupling agent containing amino groups) (manufactured by Shin-Etsu Chemicals, Co., Ltd. under the product name of KBE-903)
(b2) 3-glycidoxypropyl triethoxysilane (silane coupling agent containing epoxy groups) (manufactured by Shin-Etsu Chemicals, Co., Ltd. under the product name of KBE-403)

<(c) Component: Maleic Anhydride Grafted Polymer>
(c1): maleic anhydride-grafted polyphenylene ether

A maleic anhydride-grafted polyphenylene ether was prepared by dry-blending 95% by mass of a polyphenylene ether prepared through oxidative polymerization of 2,6-xylenol (having a reduction viscosity of 0.42 dL/g measured at 30° C. in a chloroform solution at a concentrations of 0.5 g/dL) and 5% by mass of maleic anhydride, and melt-kneading the blend using a twin-screw extruder ZSK-40 (manufactured by Coperion GmbH) under the conditions of an extrusion temperature of 250 to 320° C., a screw rotational speed of 300 rpm, and a discharge speed of 100 kg/hour. The maleic anhydride grafting content in this case was 1.03% by mass.
(c2): maleic anhydride-grafted polyphenylene ether

A maleic anhydride-grafted polyphenylene ether was prepared by dry-blending 97.0% by mass of a polyphenylene ether prepared through oxidative polymerization of 2,6-xylenol (having a reduction viscosity of 0.42 dL/g measured at 30° C. in a chloroform solution at a concentrations of 0.5 g/dL) and 3.0% by mass of maleic anhydride, and melt-kneading the blend using the twin-screw extruder ZSK-40 (manufactured by Coperion GmbH) under the conditions of an extrusion temperature of 250 to 320° C., a screw rotational speed of 300 rpm, and a discharge speed of 100 kg/hour. The maleic anhydride grafting content in this case was 0.62% by mass.
(c3): maleic anhydride-grafted polyphenylene ether

A maleic anhydride-grafted polyphenylene ether was prepared by dry-blending 99.8% by mass of a polyphenylene ether prepared through oxidative polymerization of 2,6-xylenol (having a reduction viscosity of 0.42 dL/g measured at 30° C. in a chloroform solution at a concentrations of 0.5 g/dL) and 0.2% by mass of maleic anhydride, and melt-kneading the blend using the twin-screw extruder ZSK-40 (manufactured by Coperion GmbH) under the conditions of an extrusion temperature of 250 to 320° C., a screw rotational speed of 300 rpm, and a discharge speed of 100 kg/hour. The maleic anhydride grafting content in this case was 0.08% by mass.
(c4): maleic anhydride-grafted hydrogenated block copolymer

A maleic anhydride-grafted hydrogenated block copolymer was prepared by dry-blending 96.5% by mass of Kraton™ G1650 (manufactured by Clayton Corporation), 2.0% by mass of maleic anhydride, and 1.5% by mass of PERHEXA™ 25B-40 (manufactured by NOF Corporation Co., Ltd.), and melt-kneading the blend using the twin-screw extruder ZSK-40 (manufactured by Coperion GmbH) under the conditions of an extrusion temperature of 220 to 260° C., a screw rotational speed of 300 rpm, and a discharge speed of 80 kg/hour. The maleic anhydride grafting content in this case was 1.08% by mass.
(c5): maleic anhydride-grafted hydrogenated block copolymer

A maleic anhydride-grafted hydrogenated block copolymer was prepared by dry-blending 98% by mass of Kraton™ G1650 (manufactured by Clayton Corporation), 1.2% by mass of maleic anhydride, and 0.8% by mass of PERHEXA™ 25B-40 (manufactured by NOF Corporation Co., Ltd.), and melt-kneading the blend using the twin-screw extruder ZSK-40 (manufactured by Coperion GmbH) under the conditions of an extrusion temperature of 220 to 260° C., a screw rotational speed of 300 rpm, and a discharge speed of 80 kg/hour. The maleic anhydride grafting content in this case was 0.51% by mass.

(c6): maleic anhydride-grafted hydrogenated block copolymer

A maleic anhydride-grafted hydrogenated block copolymer was prepared by dry-blending 99.5% by mass of Kraton™ G1650 (manufactured by Clayton Corporation), 0.3% by mass of maleic anhydride, and 0.2% by mass of PERHEXA™ 25B-40 (manufactured by NOF Corporation Co., Ltd.), and melt-kneading the blend using the twin-screw extruder ZSK-40 (manufactured by Coperion GmbH) under the conditions of an extrusion temperature of 220 to 260° C., a screw rotational speed of 300 rpm, and a discharge speed of 80 kg/hour. The maleic anhydride grafting content in this case was 0.07% by mass.

The maleic anhydride grafting content was determined by the method described in JP2008-134087A (sodium methylate titration method).

<(d) Component: Other Components>
(d1): urethane resin

A reactor equipped with a stirrer and a thermal control device was charged with 100 parts by mass of polyoxyethylene glycol PEG-1000 (manufactured by Sanyo Chemical Industries, Ltd.), and was substituted with nitrogen. The temperature was raised to 80° C. in a dry nitrogen atmosphere, and 15.6 parts by mass of toluene diisocyanate, CORONATE T-80 (manufactured by Nippon Polyurethane Industry Co., Ltd.) was charged, followed by aging at 80° C. for 5 hours to prepare a polyurethane resin.
(d2): maleic anhydride styrene copolymer (Dylark™ 232, manufactured by NOVA Chemicals Corporation)

The procedures for determining physical properties of the resin reinforcing fiberglass in Examples and Comparative Examples will be described.

### (Loss on Ignition)

The losses on ignition (in % by mass) of the resin reinforcing fiberglass fabricated in Examples and Comparative Examples were determined according to the JIS R3420.

### Examples 1 to 11 and Comparative Examples 1 to 4

A treatment solution containing 30% by mass of the (b) component and 70% by mass of purified water, and a treatment solution containing 10% by mass of the (c) or (d) component and 90% by mass of toluene were prepared. Next, the treatment solution containing the (b) component was sprayed on the (a) component, and was dried under vacuum at 80° C. for 3 hours. Next, the treatment solution containing the (c) component or the (d) component was sprayed and dried under vacuum at 80° C. for 3 hours. The adhesion amount of each component was varied by varying the amount sprayed. The amounts of the (b), (c) and (d) components enlisted in Table 1 were the amounts of these components added, excluding purified water or toluene. These surface-treated rovings were cut with a craft knife to a length of 3 mm to prepare a resin reinforcing fiberglass enlisted in Table 1.

The results of measurements of the loss on ignition of the resultant resin reinforcing fiberglass are summarized in Table 1.

TABLE 1

| | | | | Examples | | | | | | | |
|---|---|---|---|---|---|---|---|---|---|---|---|
| | | | | 1 | 2 | 3 | 4 | 5 | 6 | 7 | 8 |
| Compositions | (a) component | | % by mass | 98.5 | 98.5 | 98.5 | 98.5 | 98.5 | 98.5 | 98.5 | 98.98 |
| | (b) | (b1) | % by mass | 0.5 | 0.5 | 0.5 | 0.5 | 0.5 | 0.5 | | 0.02 |
| | component | (b2) | % by mass | | | | | | | 0.5 | |
| | (c) | (c1) | % by mass | 1.0 | | | | | | 1.0 | 1.00 |
| | component | (c2) | % by mass | | 1.0 | | | | | | |
| | | (c3) | % by mass | | | 1.0 | | | | | |
| | | (c4) | % by mass | | | | 1.0 | | | | |
| | | (c5) | % by mass | | | | | 1.0 | | | |
| | | (c6) | % by mass | | | | | | 1.0 | | |
| | (d) | (d1) | % by mass | | | | | | | | |
| | component | (d2) | % by mass | | | | | | | | |

| | | | | | | | | | | |
|---|---|---|---|---|---|---|---|---|---|---|
| Physical | Loss on ignition | % by mass | 1.34 | 1.35 | 1.34 | 1.35 | 1.35 | 1.35 | 1.39 | 1.02 |
| Property | | | | | | | | | | |

| | | | Examples | | | Comparative Examples | | | |
|---|---|---|---|---|---|---|---|---|---|
| | | | 9 | 10 | 11 | 1 | 2 | 3 | 4 |
| Compositions | (a) component | % by mass | 97.80 | 99.47 | 94.00 | 100 | 99.5 | 99.1 | 98.5 |

| | | | | | | | | |
|---|---|---|---|---|---|---|---|---|
| (b) | (b1) | % by mass | 1.20 | 0.50 | 0.50 | 0.5 | 0.5 | 0.50 |
| component | (b2) | % by mass | | | | | | |
| (c) | (c1) | % by mass | 1.00 | 0.03 | 5.50 | | | |
| component | (c2) | % by mass | | | | | | |
| | (c3) | % by mass | | | | | | |
| | (c4) | % by mass | | | | | | |
| | (c5) | % by mass | | | | | | |
| | (c6) | % by mass | | | | | | |
| (d) | (d1) | % by mass | | | | | 0.4 | |
| component | (d2) | % by mass | | | | | | 1.0 |

| | | | | | | | | | |
|---|---|---|---|---|---|---|---|---|---|
| Physical | Loss on ignition | % by mass | 1.85 | 0.37 | 5.83 | 0.05 | 0.35 | 0.76 | 1.35 |
| Property | | | | | | | | | |

[Thermoplastic Resin Composition]

### <Resin Reinforcing Fiberglass>

The fiberglasses prepared in Examples 1 to 11 and Comparative Examples 1 to 4 were used.

<Thermoplastic Resin>
(e1): Denatured PPE Zylon® 600H (manufactured by Asahi Kasei Corporation; Zylon is a registered trademark in Japan, other countries, or both).
(e2): PS PSJ-polystyrene® 680 (manufactured by PS Japan Corporation; PSJ-polystyrene is a registered trademark in Japan, other countries, or both).
(e3): AS Styrack® 767 (manufactured by Asahi Kasei Corporation; Styrack is a registered trademark in Japan, other countries, or both).
(e4): PA6 UBE Nylon® 1013B (manufactured by Ube Industries, Ltd.; UBE Nylon is a registered trademark in Japan, other countries, or both).
(e5): PA66 Leona® 1300 (manufactured by Asahi Kasei Corporation, Leona is a registered trademark in Japan, other countries, or both).
(e6): PP POLIMAXX polypropylene homopolymer 1100NK (manufactured by IRPC Public Company Limited).

The methods of measuring the physical properties used in Examples and Comparative Examples are as follows.

### ((1) Impact Resistance)

Pellets of each thermoplastic resin compositions prepared in Examples and Comparative Examples were fed to a screw-in-line type injection molding machine set at a cylinder temperature of 220 to 290° C. and a mold temperature of 40 to 90° C., to mold a type A test piece according to the ISO 10724-1. The Charpy impact strength (KJ/m²) of this test piece was measured according to JIS K7111-1.

((2) Adhesion of Fiberglass (GF))

The broken surface of the test piece after the above-described measurement of the Charpy impact strength of (1) was observed under a field emission scanning electron microscope (FE-SEM/EDX) (manufactured by JEOL Ltd. under the product name of JSM-6700F). The adhesions were evaluated according to the following evaluation criteria:

### <Evaluation Criteria>

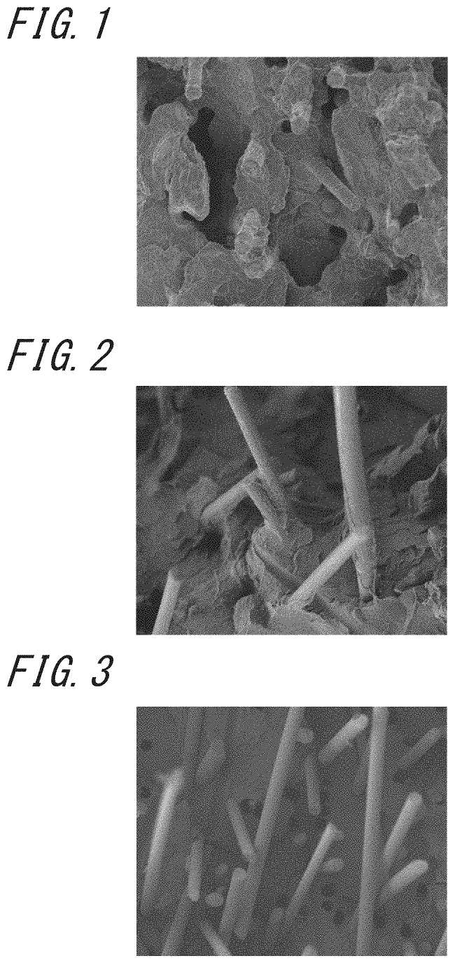

G (good adhesion): a considerable amount of the resin was adhered to the fiberglass (see FIG. 1)

I (intermediate adhesion): a small amount of the resin was adhered to the fiberglass (see FIG. 2)

P (poor adhesion): little or no resin was adhered to the fiberglass (see FIG. 3)

### ((3) Vibration Fatigue Resistance Characteristic)

The pellets of each thermoplastic resin compositions prepared in Examples and Comparative Examples were fed to the screw-in-line type injection molding machine set at a cylinder temperature of 220 to 290° C., to mold a vibration fatigue test piece using a ASTM-D671 TYPE1 mold under the condition of a mold temperature of 40 to 90° C. The obtained test piece was subjected under a load (39.2 N) at a frequency of 30 Hz in an atmosphere of 23° C. using a vibration fatigue tester (manufactured by Toyo Seiki Seisaku-sho, Ltd. under the product name of B-70) according to the JIS K7119, and the number of vibration in which a failure occurred was determined.

A sample with a greater number of vibrations to failure was determined to have a greater vibration fatigue resistance.

((4) Anti-Mold Fouling Property)

The pellets of each thermoplastic resin compositions prepared in Examples and Comparative Examples were fed to the screw-in-line type injection molding machine set at a cylinder temperature of 220 to 290° C., and continuous molding was carried out under the condition of a mold temperature of 40 to 90° C. using a weld mold (which was made in a plate-shape of a length of 38 mm, a width of 79 mm, and a thickness of 5 mm, and had a weld part in the horizontal center, and respective gates at 8-mm left and right from the weld part) without a gas escape. The gloss of a weld part of the mold was measured using an ultra high gloss checker IG-410 (manufactured by Horiba Ltd.) (range: 1,000 modes), and the number of molding shots until the gloss difference reached 100 was determined as an index for evaluating mold fouling. The gloss difference was calculated by subtracting the post-molding gloss from the pre-molding gloss.

A thermoplastic resin composition having a greater number of molding shots was determined to have lower mold fouling.

### Examples 12 to 27 and Comparative Examples 5 to 15

Respective thermoplastic resin compositions were prepared using the twin-screw extruder ZSK-40 (manufactured by Coperion GmbH). This twin-screw extruder had a first raw material feed inlet provided upstream to the flow direction of the raw materials, a first vacuum vent and a second raw material feed inlet provided downstream to the first raw material feed inlet, and a second vacuum vent provided downstream to the first vacuum vent and the second raw material feed inlet.

Using the extruder configured as described above, a thermoplastic resin and a resin reinforcing fiberglass were fed in the compositions and the production conditions enlisted in Tables 2 and 3, and were melt-kneaded under the conditions of an extrusion temperature of 240 to 300° C., a rotational speed of the screws of 300 rpm, and a discharging amount of 100 kg/hour to produce pellets of the thermoplastic resin composition.

The above-described physical properties were determined using the resultant pellets of the thermoplastic resin composition. The results of the evaluations are summarized in Tables 2 to 3.

TABLE 2

| | | | | | Examples | | | | |
|---|---|---|---|---|---|---|---|---|---|
| | | | | | 12 | 13 | 14 | 15 | 16 |
| Compositions | First | Thermoplastic | (e1) | % by mass | 70 | 70 | 70 | 70 | 70 |
| and | raw | resins | (e2) | % by mass | | | | | |
| production | material | | (e3) | % by mass | | | | | |
| conditions | feed | | (e4) | % by mass | | | | | |
| | inlet | | (e5) | % by mass | | | | | |
| | | | (e6) | % by mass | | | | | |
| | | | (c2) | % by mass | | | | | |
| | | | (c5) | % by mass | | | | | |
| | Second | Resin | Example 1 | % by mass | 30 | | | | |
| | raw | reinforcing | Example 2 | % by mass | | 30 | | | |
| | material | fiberglass | Example 3 | % by mass | | | 30 | | |
| | feed | | Example 4 | % by mass | | | | 30 | |
| | inlet | | Example 5 | % by mass | | | | | 30 |
| | | | Example 6 | % by mass | | | | | |
| | | | Example 7 | % by mass | | | | | |
| | | | Example 8 | % by mass | | | | | |
| | | | Example 9 | % by mass | | | | | |
| | | | Example 10 | % by mass | | | | | |
| | | | Example 11 | % by mass | | | | | |
| | | | Comparative | % by mass | | | | | |
| | | | Example 1 | | | | | | |
| | | | Comparative | % by mass | | | | | |
| | | | Example 2 | | | | | | |
| | | | Comparative | % by mass | | | | | |
| | | | Example 3 | | | | | | |
| | | | Comparative | % by mass | | | | | |
| | | | Example 4 | | | | | | |

| | | | | | | | |
|---|---|---|---|---|---|---|---|
| | Extrusion temperature | ° C. | 300 | 300 | 300 | 300 | 300 |
| | Temperatures in | ° C. | 290/90 | 290/90 | 290/90 | 290/90 | 290/90 |
| | injection molding | | | | | | |
| | machine (cylinder/ | | | | | | |
| | mold) | | | | | | |
| Physical | GF adhesion | — | G | G | G | G | G |
| Properties | Impact resistance | kJ/m² | 11.7 | 11.6 | 10.1 | 13.1 | 12.8 |
| | (Charpy impact | | | | | | |
| | strength) | | | | | | |
| | Vibration fatigue | Times | 15215364 | 15116608 | 14208655 | 12465798 | 12166987 |
| | resistance | | | | | | |
| | characteristic | | | | | | |
| | Anti-mold fouling | Shots | >500 | >500 | >500 | >500 | >500 |
| | property | | | | | | |

| | | | | | Examples | | | |
|---|---|---|---|---|---|---|---|---|
| | | | | | 17 | 18 | 19 | 20 |
| Compositions | First | Thermoplastic | (e1) | % by mass | 70 | 70 | 70 | 70 |
| and | raw | resins | (e2) | % by mass | | | | |
| production | material | | (e3) | % by mass | | | | |
| conditions | feed | | (e4) | % by mass | | | | |
| | inlet | | (e5) | % by mass | | | | |
| | | | (e6) | % by mass | | | | |
| | | | (c2) | % by mass | | | | |
| | | | (c5) | % by mass | | | | |
| | Second | Resin | Example 1 | % by mass | | | | |
| | raw | reinforcing | Example 2 | % by mass | | | | |
| | material | fiberglass | Example 3 | % by mass | | | | |
| | feed | | Example 4 | % by mass | | | | |
| | inlet | | Example 5 | % by mass | | | | |
| | | | Example 6 | % by mass | 30 | | | |
| | | | Example 7 | % by mass | | 30 | | |
| | | | Example 8 | % by mass | | | 30 | |
| | | | Example 9 | % by mass | | | | 30 |
| | | | Example 10 | % by mass | | | | |
| | | | Example 11 | % by mass | | | | |
| | | | Comparative | % by mass | | | | |
| | | | Example 1 | | | | | |
| | | | Comparative | % by mass | | | | |
| | | | Example 2 | | | | | |
| | | | Comparative | % by mass | | | | |
| | | | Example 3 | | | | | |
| | | | Comparative | % by mass | | | | |
| | | | Example 4 | | | | | |

| | | | | | | |
|---|---|---|---|---|---|---|
| | Extrusion temperature | ° C. | 300 | 300 | 300 | 300 |
| | Temperatures in | ° C. | 290/90 | 290/90 | 290/90 | 290/90 |
| | injection molding | | | | | |
| | machine (cylinder/ | | | | | |
| | mold) | | | | | |
| Physical | GF adhesion | — | G | G | I | G |
| Properties | Impact resistance | kJ/m² | 11.1 | 11.5 | 8.4 | 11.7 |
| | (Charpy impact | | | | | |
| | strength) | | | | | |
| | Vibration fatigue | Times | 10021542 | 17562376 | 844495 | 14998321 |
| | resistance | | | | | |
| | characteristic | | | | | |
| | Anti-mold fouling | Shots | >500 | >500 | >500 | >500 |
| | property | | | | | |

| | | | | | Examples | | | |
|---|---|---|---|---|---|---|---|---|
| | | | | | 21 | 22 | 23 | 24 |
| Compositions | First | Thermoplastic | (e1) | % by mass | 70 | 70 | | |
| and | raw | resins | (e2) | % by mass | | | 70 | |
| production | material | | (e3) | % by mass | | | | 70 |
| conditions | feed | | (e4) | % by mass | | | | |
| | inlet | | (e5) | % by mass | | | | |
| | | | (e6) | % by mass | | | | |
| | | | (c2) | % by mass | | | | |
| | | | (c5) | % by mass | | | | |
| | Second | Resin | Example 1 | % by mass | | | | |
| | raw | reinforcing | Example 2 | % by mass | | | 30 | 30 |
| | material | fiberglass | Example 3 | % by mass | | | | |
| | feed | | Example 4 | % by mass | | | | |
| | inlet | | Example 5 | % by mass | | | | |
| | | | Example 6 | % by mass | | | | |
| | | | Example 7 | % by mass | | | | |
| | | | Example 8 | % by mass | | | | |
| | | | Example 9 | % by mass | | | | |
| | | | Example 10 | % by mass | 30 | | | |
| | | | Example 11 | % by mass | | 30 | | |
| | | | Comparative | % by mass | | | | |
| | | | Example 1 | | | | | |
| | | | Comparative | % by mass | | | | |
| | | | Example 2 | | | | | |
| | | | Comparative | % by mass | | | | |
| | | | Example 3 | | | | | |
| | | | Comparative | % by mass | | | | |
| | | | Example 4 | | | | | |

| | | | | | | |
|---|---|---|---|---|---|---|
| | Extrusion temperature | ° C. | 300 | 300 | 240 | 240 |
| | Temperatures in | ° C. | 290/90 | 290/90 | 220/45 | 240/60 |
| | injection molding | | | | | |
| | machine (cylinder/ | | | | | |
| | mold) | | | | | |
| Physical | GF adhesion | — | I | G | G | G |
| Properties | Impact resistance | kJm² | 8.3 | 11.8 | 7.2 | 6.6 |
| | (Charpy impact | | | | | |
| | strength) | | | | | |
| | Vibration fatigue | Times | 3511691 | 16893452 | 846912 | 936512 |
| | resistance | | | | | |
| | characteristic | | | | | |
| | Anti-mold fouling | Shots | >500 | >500 | >500 | >500 |
| | property | | | | | |

| | | | | | Examples | | |
|---|---|---|---|---|---|---|---|
| | | | | | 25 | 26 | 27 |
| Compositions | First | Thermoplastic | (e1) | % by mass | | | |
| and | raw | resins | (e2) | % by mass | | | |
| production | material | | (e3) | % by mass | | | |
| conditions | feed | | (e4) | % by mass | 70 | | |
| | inlet | | (e5) | % by mass | | 70 | |
| | | | (e6) | % by mass | | | 70 |
| | | | (c2) | % by mass | | | |
| | | | (c5) | % by mass | | | |
| | Second | Resin | Example 1 | % by mass | | | |
| | raw | reinforcing | Example 2 | % by mass | 30 | 30 | |
| | material | fiberglass | Example 3 | % by mass | | | |
| | feed | | Example 4 | % by mass | | | |
| | inlet | | Example 5 | % by mass | | | 30 |
| | | | Example 6 | % by mass | | | |
| | | | Example 7 | % by mass | | | |
| | | | Example 8 | % by mass | | | |
| | | | Example 9 | % by mass | | | |
| | | | Example 10 | % by mass | | | |
| | | | Example 11 | % by mass | | | |
| | | | Comparative | % by mass | | | |
| | | | Example 1 | | | | |
| | | | Comparative | % by mass | | | |
| | | | Example 2 | | | | |
| | | | Comparative | % by mass | | | |
| | | | Example 3 | | | | |
| | | | Comparative | % by mass | | | |
| | | | Example 4 | | | | |

| | | | | | |
|---|---|---|---|---|---|
| | Extrusion temperature | ° C. | 260 | 290 | 240 |
| | Temperatures in | ° C. | 290/80 | 290/80 | 230/40 |
| | injection molding | | | | |
| | machine (cylinder/ | | | | |
| | mold) | | | | |
| Physical | GF adhesion | — | G | G | I |
| Properties | Impact resistance | kJ/m² | 17.7 | 15.9 | 8.4 |
| | (Charpy impact | | | | |
| | strength) | | | | |
| | Vibration fatigue | Times | 1256920 | 7348904 | 664392 |
| | resistance | | | | |
| | characteristic | | | | |
| | Anti-mold fouling | Shots | >500 | >500 | >500 |
| | property | | | | |

TABLE 3

| | | | | | Comparative Examples | | | | | |
|---|---|---|---|---|---|---|---|---|---|---|
| | | | | | 5 | 6 | 7 | 8 | 9 | 10 |
| Compositions | First raw | Thermoplastic | (e1) | % by mass | 70 | 70 | 70 | | | |
| and production | material | resins | (e2) | % by mass | | | | 70 | | |
| conditions | feed inlet | | (e3) | % by mass | | | | | 70 | |
| | | | (e4) | % by mass | | | | | | 70 |
| | | | (e5) | % by mass | | | | | | |
| | | | (e6) | % by mass | | | | | | |
| | | | (c2) | % by mass | | | | | | |
| | | | (c5) | % by mass | | | | | | |
| | Second raw | Resin | Example 1 | % by mass | | | | | | |
| | material | reinforcing | Example 2 | % by mass | | | | | | |
| | feed inlet | fiberglass | Example 3 | % by mass | | | | | | |
| | | | Example 4 | % by mass | | | | | | |
| | | | Example 5 | % by mass | | | | | | |
| | | | Example 6 | % by mass | | | | | | |
| | | | Example 7 | % by mass | | | | | | |
| | | | Example 8 | % by mass | | | | | | |
| | | | Example 9 | % by mass | | | | | | |
| | | | Example 10 | % by mass | | | | | | |
| | | | Example 11 | % by mass | | | | | | |
| | | | Comparative | % by mass | 30 | | | | | |
| | | | Example 1 | | | | | | | |
| | | | Comparative | % by mass | | 30 | | | | |
| | | | Example 2 | | | | | | | |
| | | | Comparative | % by mass | | | 30 | 30 | 30 | 30 |
| | | | Example 3 | | | | | | | |
| | | | Comparative | % by mass | | | | | | |
| | | | Example 4 | | | | | | | |

| | | | | | | | | |
|---|---|---|---|---|---|---|---|---|
| | Extrusion temperature | ° C. | 300 | 300 | 300 | 240 | 240 | 260 |
| | Temperatures in injection molding machine | ° C. | 290/90 | 290/90 | 290/90 | 220/45 | 240/60 | 290/80 |
| | (cylinder/mold) | | | | | | | |
| Physical | GF adhesion | — | P | I | I | P | P | P |
| Properties | Impact resistance | kJ/m² | 5.8 | 8.4 | 8.2 | 5.5 | 4.8 | 14.5 |
| | (Charpy impact strength) | | | | | | | |
| | Vibration fatigue resistance characteristic | Times | 134279 | 3785745 | 3511678 | 84991 | 99823 | 775412 |
| | Anti-mold fouling property | Shots | >500 | >500 | 356 | 307 | 402 | 453 |

| | | | | | Comparative Examples | | | | |
|---|---|---|---|---|---|---|---|---|---|
| | | | | | 11 | 12 | 13 | 14 | 15 |
| Compositions | First raw | Thermoplastic | (e1) | % by mass | | | 69.5 | 69.5 | 70 |
| and production | material | resins | (e2) | % by mass | | | | | |
| conditions | feed inlet | | (e3) | % by mass | | | | | |
| | | | (e4) | % by mass | | | | | |
| | | | (e5) | % by mass | 70 | | | | |
| | | | (e6) | % by mass | | 70 | | | |
| | | | (c2) | % by mass | | | 0.5 | | |
| | | | (c5) | % by mass | | | | 0.5 | |
| | Second raw | Resin | Example 1 | % by mass | | | | | |
| | material | reinforcing | Example 2 | % by mass | | | | | |
| | feed inlet | fiberglass | Example 3 | % by mass | | | | | |
| | | | Example 4 | % by mass | | | | | |
| | | | Example 5 | % by mass | | | | | |
| | | | Example 6 | % by mass | | | | | |
| | | | Example 7 | % by mass | | | | | |
| | | | Example 8 | % by mass | | | | | |
| | | | Example 9 | % by mass | | | | | |
| | | | Example 10 | % by mass | | | | | |
| | | | Example 11 | % by mass | | | | | |
| | | | Comparative | % by mass | | | | | |
| | | | Example 1 | | | | | | |
| | | | Comparative | % by mass | | | | | |
| | | | Example 2 | | | | | | |
| | | | Comparative | % by mass | 30 | 30 | 30 | 30 | |
| | | | Example 3 | | | | | | |
| | | | Comparative | % by mass | | | | | 30 |
| | | | Example 4 | | | | | | |

| | | | | | | | |
|---|---|---|---|---|---|---|---|
| | Extrusion temperature | ° C. | 290 | 240 | 300 | 300 | 300 |
| | Temperatures in injection molding machine | ° C. | 290/80 | 230/40 | 290/90 | 290/90 | 290/90 |
| | (cylinder/mold) | | | | | | |
| Physical | GF adhesion | — | P | P | I | P | P |
| Properties | Impact resistance | kJ/m² | 13.8 | 6.1 | 8.1 | 8.3 | 6.4 |
| | (Charpy impact strength) | | | | | | |
| | Vibration fatigue resistance characteristic | Times | 884365 | 32985 | 157843 | 984712 | 8354792 |
| | Anti-mold fouling property | Shots | 439 | 208 | 403 | 394 | 322 |

As summarized in Tables 2 to 3, it was found that the thermoplastic resin compositions of Examples 12 to 27 were excellent in the impact resistances and the vibration fatigue resistance characteristics because the adhesions of the resins to the fiberglasses were improved, and their anti-mold fouling properties were also excellent.

The thermoplastic resin compositions of Comparative Examples 5 to 15 were inferior in any of the GF adhesions, impact resistances, vibration fatigue resistance characteristics, and anti-mold fouling properties, to those of Examples.

### INDUSTRIAL APPLICABILITY

The thermoplastic resin composition including the resin reinforcing fiberglass of the present embodiment can reduce mold fouling during molding, which can improve the productivity. Further, molded articles thereof have high impact resistances and high vibration fatigue resistance characteristics, thereby increasing the degree of freedom of designs of resin molded articles. Thus, they can be used as various components in electric and electronic appliances, automobile appliances, chemical appliances, and optical appliances, and has industrial applicability as chassis and cabinets of digital versatile disks etc., component parts of optical appliances such as optical pickup slide bases, components around light source lamps, sheets or films for stack substrates of metallic films, internal components of hard disks, connector ferrules for optical fibers, internal components for laser beam printers (such as toner cartridges), internal components for ink jet printers, internal components for copiers, plumbing pumps and piping members, components in automobile engine rooms such as parts of automobile radiator tanks, components of lamps of automobiles, and the like.

1. A resin reinforcing fiberglass comprising:
(a) a fiberglass; and
(b) a silane coupling agent and (c) a maleic anhydride grafted polymer, which are adhered to a surface of the (a) fiberglass.

2. The resin reinforcing fiberglass according to claim 1, wherein the fiberglass is in a form selected from the group consisting of a roving, chopped strands, milled fibers, yarns, a woven fabric, and a nonwoven fabric.

3. The resin reinforcing fiberglass according to claim 1, wherein 0.03 to 1.00% by mass of the (b) silane coupling agent, and the (c) maleic anhydride grafted polymer are adhered to the surface of 94.0 to 99.92% by mass of the (a) fiberglass.

4. The resin reinforcing fiberglass according to claim 1, wherein the (b) silane coupling agent, and 0.05 to 5.00% by mass of the (c) maleic anhydride grafted polymer are adhered to the surface of 94.0 to 99.92% by mass of the (a) fiberglass.

5. The resin reinforcing fiberglass according to claim 1, wherein the (b) silane coupling agent has an amino group or an epoxy group.

6. The resin reinforcing fiberglass according to claim 1, wherein the (c) maleic anhydride grafted polymer is a polymer in which maleic anhydride is grafted to a polyphenylene ether, or in which maleic anhydride is grafted to a hydrogenated block copolymer resultant from a hydrogenation of a block copolymer containing two or more polymer blocks A composed mainly of a vinyl aromatic compound and one or more polymer blocks B composed mainly of a conjugated diene compound.

7. The resin reinforcing fiberglass according to claim 1, wherein the (c) maleic anhydride grafted polymer has a maleic anhydride grafting content of 0.1 to 1.0% by mass.

8. The resin reinforcing fiberglass according to claim 2, wherein 0.03 to 1.00% by mass of the (b) silane coupling agent, and the (c) maleic anhydride grafted polymer are adhered to the surface of 94.0 to 99.92% by mass of the (a) fiberglass.

9. The resin reinforcing fiberglass according to claim 2, wherein the (b) silane coupling agent, and 0.05 to 5.00% by mass of the (c) maleic anhydride grafted polymer are adhered to the surface of 94.0 to 99.92% by mass of the (a) fiberglass.

10. The resin reinforcing fiberglass according to claim 2, wherein the (b) silane coupling agent has an amino group or an epoxy group.

11. The resin reinforcing fiberglass according to claim 2, wherein the (c) maleic anhydride grafted polymer is a polymer in which maleic anhydride is grafted to a polyphenylene ether, or in which maleic anhydride is grafted to a hydrogenated block copolymer resultant from a hydrogenation of a block copolymer containing two or more polymer blocks A composed mainly of a vinyl aromatic compound and one or more polymer blocks B composed mainly of a conjugated diene compound.

12. The resin reinforcing fiberglass according to claim 2, wherein the (c) maleic anhydride grafted polymer has a maleic anhydride grafting content of 0.1 to 1.0% by mass.
